(19) United States
(12) Patent Application Publication
(10) Pub. No.: US 2018/0321809 A1
(43) Pub. Date: Nov. 8, 2018

(54) METHOD FOR CREATING A MENU STRUCTURE ON A MEASURING TRANSDUCER, AND MEASURING TRANSDUCER

(71) Applicant: Endress+Hauser Conducta GmbH+Co. KG, Gerlingen (DE)

(72) Inventor: Stefan Robl, Hunxe (DE)

(21) Appl. No.: 15/971,922

(22) Filed: May 4, 2018

(30) Foreign Application Priority Data
May 5, 2017 (DE) 10 2017 109 711.2

(51) Int. Cl. G06F 3/0484; G06F 3/0482

(52) U.S. Cl. CPC G06F 3/0484; G06F 3/0482

(57) ABSTRACT

The present disclosure relates to a method for creating a menu structure on a measuring transducer of process automation technology, wherein the measuring transducer can be connected to at least one field device, comprising: connecting a field device to the measuring transducer; transmitting a field-device-specific menu structure from the field device to the measuring transducer if it is not already available on the measuring transducer; and combining the field-device-specific menu structure with a measuring-transducer-specific menu structure to a common menu structure using at least one anchor point or a placeholder in the measuring-transducer-specific menu structure. The present disclosure further relates to a measuring transducer for implementing the method.

### CROSS-REFERENCE TO RELATED APPLICATION

The present application is related to and claims the priority benefit of German Patent Application No. 10 2017 109 711.2, filed on May 5, 2017, the entire contents of which are incorporated herein by reference.

### TECHNICAL FIELD

The present disclosure relates to a method for creating a menu structure on a measuring transducer of process automation technology. The present disclosure further relates to a measuring transducer for implementing the method.

### BACKGROUND

Generally speaking, a measuring transducer—also called a transmitter—is a device that converts an input variable into an output variable according to a fixed relationship. In process automation technology, a field device, for example, is connected to a measuring transducer. The field device is a sensor, for example. Its raw measured values are processed in the measuring transducer, e.g., averaged or converted by means of a calibration model to another variable—for example, the process variable to be determined, and possibly transmitted, e.g., to a control system.

Generally, a cable for connection to the sensor is connected to the measuring transducer. The measuring transducer is in this case a separate device with a separate housing and various interfaces. Alternatively, the measuring transducer can be integrated, e.g., in the form of a circuit—possibly as a microcontroller or something similar—into a cable or directly into a plug connection (see below).

The connection of the cable to the sensor is frequently accomplished via a plug connection, e.g., by galvanically decoupled—especially, inductive—interfaces. Thus, electrical signals can be transmitted contactlessly. Advantages with regard to corrosion protection, electrical isolation, prevention of mechanical wear of the plug, etc., are shown by this galvanic isolation. The applicant markets such systems under the name, “Memosens.”

The most varied sensors can be connected to the measuring transducer. Under the aforementioned name, “Memosens,” the applicant markets sensors for measuring pH value, conductivity, oxygen, turbidity, and other things.

The field device connected to the measuring transducer, i.e., the sensor, for example, is parameterized, and other settings are changed via the measuring transducer. For this purpose, the measuring transducer has a display and possibilities for making entries, e.g., via buttons, switches, touch display, or via external devices that are connected to the measuring transducer via a wireless or wired interface (such as USB, serial or parallel interface, RS-232, Bluetooth, etc.).

An appropriate menu is shown on the display. In the sense of the present application, the term, “menu structure,” is used. The menu structure comprises the entirety of all menu pages and the navigation therein. The menu structure thus describes the hierarchy, navigation, and texts of the various menu pages that are shown on the display of the measuring transducer, in order to guide the user. The menu structure allows for selecting from an offering and manipulating or executing a desired setting or a command. Adjustments, both on the measuring transducer and for the field device connected thereto (for example, the sensor), are made via the menu structure.

The menu structure varies depending upon the connected field device, i.e., depending upon the sensor type, since each sensor type can have different measurands, parameters, and functions. In other words, each of the connected field devices, i.e., also each connected sensor, requires software specific to the device from the measuring transducer. This applies, on the one hand, to the device driver, but also to the menu structure. The measuring transducer must know which type of sensor is connected, in order to provide the appropriate menu structure for the sensor. To this end, each sensor has an identification that is unique for its type and that is sent to a measuring transducer when the sensor is connected. For a sensor known to the measuring transducer, signal processing routines, parameters, field bus connection, etc., are also respectively provided in the measuring transducer, in addition to the menu structure. As mentioned, the sensor, via the measuring transducer, is parameterized, adjusted, and adapted to the process to be measured.

Since a wide variety of sensors can be connected to the measuring transducer, and since the software, including the menu structure, in the measuring transducer for a sensor is comprehensive, the production, maintenance, and testing of the operating software of the measuring transducer is very complex and expensive.

If a new sensor is to be supported by the measuring transducer, e.g., a new generation of a known sensor or a completely new sensor, the operating software of the measuring transducer must be adapted—if necessary, completely. This new software must be distributed to all previous measuring transducers. Only after this distribution are all measuring transducers able to completely support the new sensor.

### SUMMARY

The present disclosure is based upon the aim of simplifying the creation and maintenance of the software of the measuring transducer and, at the same time, achieving a subsequent expandability of a measuring transducer without having to replace its operating software. The user is, in particular, to be enabled to control a field device connected to the measuring transducer via the menu structure, even if the field device is still unknown at the time the measuring transducer is delivered.

The aim is achieved by a method comprising at least the steps: connecting a field device to a measuring transducer; transmitting a field-device-specific menu structure from the field device to the measuring transducer if it is not already available on the measuring transducer; and combining the field-device-specific menu structure with a measuring-transducer-specific menu structure to a common menu structure by means of at least one anchor point or a placeholder in the measuring-transducer-specific menu structure, wherein the measuring-transducer-specific menu structure is located in the measuring transducer, wherein the anchor point or the placeholder determines where the field-device-specific menu structure is integrated into the measuring-transducer-specific menu structure, wherein the anchor point is a reference to a complete menu page of the field-device-specific menu structure, wherein the anchor point is only displayed in the common menu structure if a corresponding menu page exists in the field-device-specific menu structure, and wherein the placeholder is at least one element of the field-device-specific menu structure within a menu page of the common menu structure.

In order to allow for a generic approach to various field devices connected to the measuring transducer, the menu structure is stored on the side of the field device and transmitted to the measuring transducer when needed. There are different scenarios in this respect: the menu structure can be stored in the memory, e.g., in the cache, of the measuring transducer if the measuring transducer was already connected to the field device once at an earlier point in time. The cache stores the menu structure temporarily and thus makes it possible that the data do not have to be transmitted again at a later point in time.

On the other hand, the menu structure may well already be firmly integrated into the measuring transducer (at the time of its delivery) and not be integrated into the main menu structure for modular reasons only (plug & play; only the descriptions that are actually being used are in use).

In one embodiment, the measuring transducer receives the menu structure via the internet or a storage medium and does not offer a menu structure for the connected field device until then.

A menu page is a collection of elements that can be static texts, parameters, or links to other menu pages.

An anchor point is a reference to a complete menu page. An anchor point is thus a submenu point, the selection of which leads the user to another menu page.

Placeholders are one or more individual elements of a foreign menu structure that are inserted into a menu page. Within a page, individual elements can come from a foreign menu structure; they are referenced via a placeholder, for example, and inserted if available. If this placeholder is not available, the individual elements are, accordingly, not displayed.

The visibility of a placeholder is effectively subject to the same condition as that of the anchor point: If the placeholder does not exist in the field-device-specific menu navigation, it is not displayed.

Conversely, the referenced elements of a placeholder can each have a separate visibility condition, i.e., a placeholder may very well exist, but nothing is displayed because the referenced elements are not to be visible at a certain point in time—for example, because of a certain operating state of the device.

In one embodiment, the field device is a sensor.

In one embodiment, a distinction is made within the field-device-specific and measuring-transducer-specific menu structures between hierarchically structured data and their display, wherein the hierarchically structured data are at least static texts or parameters.

A distinction is thus made between the structure and its display. Display on many end devices is thus possible; ultimately, the end device decides how the data is displayed.

In one embodiment, the display is stored in the form of style sheets—for example, using the style sheet language CSS. The display is thus generally available as an explicit, separable description. The description of the display can thus be easily exchanged.

In one embodiment, the interpretation and display of the menu structure is implicitly determined by a display unit contained in the measuring transducer, i.e., there is no explicit, separable, and thus exchangeable display rule in this case.

In one embodiment, only the hierarchically structured data are transmitted from the field device to the measuring transducer.

In one embodiment, the measuring transducer comprises a first interpreter, which reads, analyzes, and executes the field-device-specific and measuring-transducer-specific menu structures at runtime and creates the common menu structure.

In general, an interpreter is a computer program that, in contrast to assemblers and compilers, does not translate a program source code into a file that can be executed directly on the system, but reads and executes the source code, step-by-step, during the analysis. The analysis of the source code takes place during the runtime of the program. Via specific interpreters, other description languages (for example, HTML) can also lead to system behavior matching the description. In the sense of the embodiment, an interpreter, for example, is provided (“first interpreter”), which processes the menu structure and results in a visual display.

In one embodiment, the measuring-transducer-specific menu structure references measuring-transducer-specific parameters stored in a first database in the measuring transducer, wherein the field-device-specific menu structure comprises field-device-specific parameters, which are stored in a second database assigned to the field device, wherein the measuring transducer comprises a management unit for at least managing the parameters, and the management unit obtains the requested parameter from the first or second database.

In one embodiment, the field device comprises the second database, and the field-device-specific parameters are stored therein.

The menu structure is written in an abstract form in a meta-language. As mentioned, it is not specified in this meta-language how data and elements, but which data and elements are displayed on which menu pages. For example, it is specified that various buttons, editable text boxes, selection menus, etc., are to be displayed on a main level. It is, moreover, specified therein which parameters are to be displayed within the individual elements.

In one embodiment, a unique identifier is assigned to each parameter, be it a field-device-specific or a measuring-transducer-specific parameter, after combining the two menu structures.

The parameters are thus referenced in the menu structure by the identifier. The aforementioned information regarding the menu structure, i.e., for example, which data and elements are displayed on which pages, is brought into a certain format—for example, into the form of a hierarchical tree structure. In one embodiment, this is a binary file. In one embodiment, this is human-readable text—for example, in the form of an XML file.

As a counterpart to the aforementioned structure information, there is the first interpreter already mentioned above. The first interpreter has the task of interpreting the abstract formulations of the menu structure and displaying it in a device-specific manner on the measuring transducer. A part of the first interpreter is specifically implemented for each end device in order to allow for a correct display of its underlying display unit.

The first interpreter displays the elements described via the menu structure and has the task of integrating the referenced parameters into the display. For this purpose, the first interpreter has an interface to the aforementioned second database (in the field device, or sensor), in order to obtain the actual parameter values for the identifiers stored in the menu structure; see the details below.

The first interpreter resolves the parameter references on the basis of their identifiers by reading them out via the aforementioned management unit, i.e., the unit for at least managing the parameters. The management unit forwards the query to the respective database, which subsequently supplies the associated value.

All measuring-transducer-specific parameters (such as the time, the setting of the power output, etc.) are stored in the aforementioned first database, extracted from it, and queried by the first interpreter. This is explained in more detail below.

The first interpreter in the measuring transducer has access to the field-device-specific menu structure as a result of the transmission of said menu structure to the measuring transducer (if it is not already located on the measuring transducer), wherein said menu structure is designed to be exclusively field-device-specific. In order to display menu pages of both the measuring transducer and the field device, the first interpreter requires both a field-device-specific and a measuring-transducer-specific menu structure.

The measuring transducer comprises a database—in the words of the present application, a “first database”—which describes all measuring-transducer-specific contents. This first database manages exclusively measuring-transducer-specific parameters. If a menu page with measuring-transducer-specific contents is to be displayed, the measuring-transducer-specific menu structure is analyzed by the first interpreter. If measuring-transducer-specific parameters are referenced by the menu structure, the management unit accordingly passes along the access to the first database that is assigned to the measuring transducer.

If the user changes in the menu to a page that is to display field-device-specific contents, such as current measured values, the second database (in the field device) is accessed by the management unit and accordingly analyzed by the second interpreter. In the second database, only field-device-specific parameters are managed. The parameters are loaded with the same mechanism as before, via the management unit of the measuring transducer, by specifying the associated identifier. All field-device-specific parameters are not physically located in the management unit of the measuring transducer. Instead, the management unit has an interface to the second database.

All parameters of the field device are stored in a separate database—in the “second database,” in the sense of this application. If the management unit of the measuring transducer does not find a referenced parameter—because the respective identifier is unknown to it and thus cannot be physically located in the first database—the management unit sends a query to the second database. If the identifier is found, the respective parameter is returned.

Via this mechanism, the first interpreter requires only the interface to a management unit. The management unit takes over the task of supplying both measuring-transducer-specific and field-device-specific parameters to the first interpreter.

In one embodiment, measuring-transducer-specific and field-device-specific parameters use different and unique identifiers in order to be able to make a distinction.

In one embodiment, the identifiers of the field devices connected to the measuring transducer overlap those of the measuring transducer. Then, when loading the menu structure of the field device, the measuring transducer checks which index range the field device parameters are located in. The measuring transducer autonomously decides which index range the field device parameters are mapped to. Deviating from any default within the field-device-specific menu structure, the field device parameters may be mapped—for example, by a constant offset in the measuring transducer—to another index range. To this end, a constant offset is, for example, added to all referenced parameters of the second database by the first interpreter. If the referenced parameter is not known, the management unit additionally subtracts the respective offset, before the query is forwarded to the second database. As a result of this method, no additional requirements as to the selection of the index ranges must be specified for the parameters. The measuring transducer now has only to ensure that a certain continuous range is provided for the field device parameters.

In one embodiment, the measuring transducer comprises at least a second interpreter for executing an extension, wherein field-device-specific software is transmitted from the field device to the measuring transducer after the field device is connected to the measuring transducer, if the software is not already located on the measuring transducer, wherein the field-device-specific software is designed as an extension, wherein the field-device-specific software comprises the field-device-specific menu structure, and wherein the field-device-specific software comprises the second database, and the field-device-specific parameters are stored therein.

In one embodiment, the second interpreter is designed as an emulator—more precisely, as a software emulator. An emulator is an interpreter, since it processes the machine code of the guest system, command-by-command or in command sequences, on a “virtual processor.” In other words, the emulator is an executing unit that executes the machine code of a certain architecture. A system that emulates another system in certain partial respects is called an emulator. The simulated system receives the same data as, executes programs comparable to, and achieves results, with respect to certain problems, as similar as possible to those of the system to be emulated. Software emulators are programs that simulate computing units and thus allow the use of software for precisely this computing unit on a computing unit with a different architecture.

The second interpreter can also be designed in the special form of an emulator, viz., in a virtual machine. The virtual machine can execute parts of the machine code of the guest system directly on the host system. The definition of“emulator” or “virtual machine” is not unambiguous in the literature, and is blurred. In the sense of this application, a “virtual machine” executes large parts of its commands natively on the CPU of the host system. Since many commands are executed directly on the CPU of the host system, the same CPU architecture must be used for the guest system as on the host system. In the process, the support of the processor and/or of the operating system of the host system is necessary, in order to allow for the abstraction between the guest system and the host system. During emulation, this is, however, not necessary. During emulation, a code deviating from the hardware or CPU can be executed. A common method is software emulation, which simulates all functions of individual hardware components in software. In this way, programs can be executed that were written for a different CPU. The software emulation can thus be realized in a platform-independent manner.

In one embodiment, the second interpreter is designed as a script language interpreter.

In one embodiment, the script language can be Lua. “Lua” is an imperative script language that allows both functional and object-oriented programming. An advantage of Lua is the small size of the compiled script interpreter and the high execution speed. Lua programs can be developed independently of the platform.

In one embodiment, one or more script language interpreters and/or emulators can be started in parallel on a measuring transducer and also operated in parallel.

If the second interpreter is started, an extension is subsequently executed on it. An extension is software that is not primarily part of the measuring transducer, i.e., it is explicitly not part of the operating software. The extension is loaded at runtime. The extension is, in particular, loaded from a memory at runtime. The memory can in this case be implemented as memory firmly integrated into the hardware of the measuring transducer (e.g., flash memory), in the form of removable memory accessible to the user (e.g., a memory card), or in the form of a network memory that is addressed by data communication (e.g., a file server).

In general, the extension is thus software code that is formulated in a certain (programming) language and executed on the measuring transducer. If the second interpreter is designed as an emulator, the extension is formulated in machine code. If the second interpreter is designed as a script language interpreter, the extension is formulated as specific software code—in the example mentioned above, as Lua code.

In one embodiment, several second interpreters can be executed per measuring transducer. In one embodiment, the second interpreter can be instantiated dynamically. The program code of the second interpreter is found once on the measuring transducer—more precisely, in a memory of the measuring transducer—and is executed when an instance is called up. An instance is in this respect a specific occurrence of an object, i.e., of the second interpreter in this case, which exists (only) during its runtime. In one embodiment, several second interpreters are already statically loaded.

In one embodiment, precisely one extension is executed per second interpreter. This results in the extensions being executable independently of one another. Otherwise, the extensions would potentially have to know about each other or be designed such that they share the resources of a second interpreter. This increases the interdependencies.

As mentioned, each measuring transducer has its own first interpreter, which interprets the field-device-specific menu structure and displays it in a system-specific manner accordingly. In addition to the generic coupling of the field device and the measuring transducer, this concept offers the advantage that the menu structure is processed by its own interpreter (the “first interpreter”), which works independently of the second interpreter. The menu structure thus does not have to be processed by the second interpreter, with an additional performance loss.

With respect to the second interpreter and the second database, the parameter management shall be discussed below.

All parameters of the field device are stored in a separate database—in a “second database,” in the sense of this application. If the management unit of the measuring transducer does not find a referenced parameter—because the respective identifier is unknown to it and thus cannot be physically located in the management unit—the management unit sends a query to the second database, which is comprised by the field-device-specific software and executed by the second interpreter. The second interpreter checks whether the identifier is known and supplies the respective parameter to the management unit. This parameter is returned by the management unit to the first interpreter. Via this mechanism, the first interpreter requires only the interface to the management unit, which appears to it as a transparent database. The management unit takes over the task of supplying both measuring-transducer-specific and field-device-specific contents to the first interpreter.

In one embodiment, the menu page to be displayed is not rendered until all hierarchically structured data to be displayed on the menu page are available on the measuring transducer. If a menu page is to be displayed right away, the respective data are located in the memory of the computing unit on the measuring transducer. In order to create the menu page, the combination of the field-device-specific and the measuring-transducer-specific menu structures must be known, and the texts and parameters must be retrieved from the respective database. The structure itself is constant and is therefore stored permanently in the memory of the measuring transducer—for example, in a flash memory.

In one embodiment, the field-device-specific menu structure is combined with the measuring-transducer-specific menu structure, menu page by menu page. In other words, elements that are measuring-transducer-specific are in this case not displayed on a page at the same time as elements that are field-device-specific. This allows for an easier implementation.

In one embodiment, the field-device-specific menu structure is combined with the measuring-transducer-specific menu structure, element by element, in one menu page. In other words, elements that are measuring-transducer-specific are in this case displayed with elements that are field-device-specific on a common page. This allows for an easier display for the user.

In one embodiment, the menu structure depends upon the state of referenced parameters. Certain elements of the menu structure are thus only displayed if, for example, a certain parameter has a certain value. An example in this respect is the visibility of a set value that is required only in a certain operating mode of the field device.

In one embodiment, the anchor point defines an entry point or an exit point. It is thus possible for the user to not only move hierarchically within the menu structure, but “jumps” across the hierarchy can also be made possible.

In one embodiment, the common menu structure comprises a menu page, which comprises all anchor points of the field-device-specific menu structure that the measuring transducer cannot integrate using the anchor points known to it at the time of its delivery. The menu structure of a field device that is connected to the measuring transducer after the time of delivery of the measuring transducer can, nonetheless, be displayed. The parts of the menu structure that are “older” and thus known to the measuring transducer are appropriately displayed using the unique identifiers. Parts of the menu structure that are “new” and thus unknown to the measuring transducer are combined in one menu page.

The aim is further achieved by a measuring transducer for implementing one of the methods described above.

### BRIEF DESCRIPTION OF THE DRAWINGS

This will be explained in more detail with reference to the following figures. These show:

FIGS. 1 A-1B show a measurement arrangement comprising a measuring transducer in two different embodiments,

FIG. 2 shows a symbolic representation of a common menu structure,

FIGS. 3A-B show a menu page of a measuring transducer with an anchor point and a menu structure of a sensor,

FIGS. 4A-C show a menu page of a measuring transducer with a placeholder, its reference, and the resulting menu page,

FIGS. 5A-C show screenshots of the display of a measuring transducer, which show various situations of the menu structure, and

FIG. 6 shows a block diagram of the connection of a measuring transducer and a field device.

### DETAILED DESCRIPTION

The claimed measuring transducer 20 is used in a sensor arrangement 10. The sensor arrangement 10 comprises a sensor 1 and a connection element 11, which shall be discussed first. Without limitation of generality, a “sensor 1” is spoken of below; even so, an actuator or the like may, however, also be connected to the measuring transducer 20. Generally, a field device is connected to the measuring transducer 20.

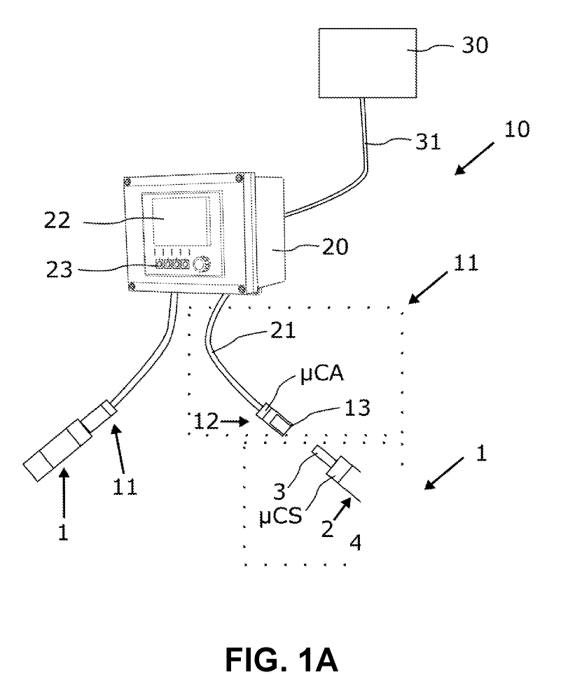

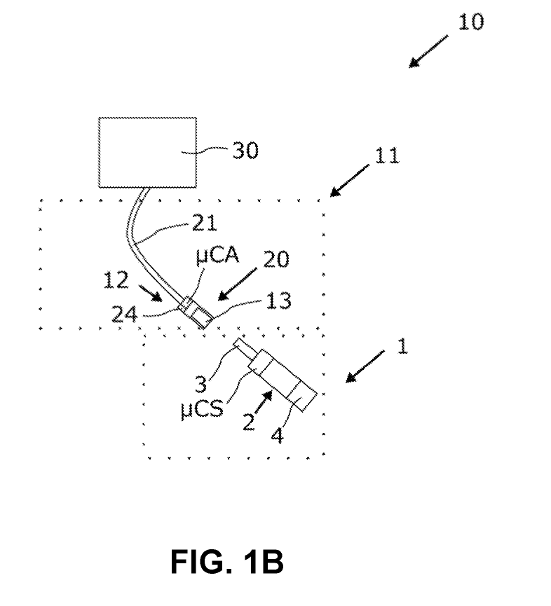

FIG. 1A represents an embodiment of a sensor arrangement 10.

A sensor 1 communicates with a measuring transducer 20 via a first physical interface 3. An alternative word for measuring transducer is transmitter. The measuring transducer 20 in turn is connected to a higher-level unit 30, such as a control system, by a cable 31. A cable 21 is connected on the sensor side to the measuring transducer 20, the other end of which cable comprises a second physical interface 13 that is complementary to the first physical interface 3. A connection element 11 comprises the cable 21, along with the second physical interface 13. The physical interfaces 3, 13 are designed as electrically isolated—in particular, inductive—interfaces. The physical interfaces 3, 13 can be coupled with each other by means of a mechanical plug connection. The mechanical plug connection is hermetically sealed, so that no fluid, such as the medium to be measured, air, or dust, can enter from the outside.

Data (bi-directional) and power (uni-directional, i.e., from the connection element 11 to the sensor 1) are transmitted or transferred via the physical interfaces 3, 13. The sensor arrangement 10 is used predominantly in process automation.

The sensor 1 comprises at least one sensor element 4 for detecting a measurand of process automation. The sensor 1 is then, for example, a pH sensor, also [called] ISFET—generally, an ion-selective sensor, a sensor for measurement of the redox potential, from the absorption of electromagnetic waves in the medium, e.g., with wavelengths in the UV, IR, and/or visible range, of the oxygen, of the conductivity, of the turbidity, of the concentration of non-metallic materials, or of the temperature, along with the respectively corresponding measurand.

The sensor 1 further comprises a first coupling body 2, which comprises the first physical interface 3. As mentioned, the first physical interface 3 is designed for the transmission to a second physical interface 13 of a value that is a function of the measurand. The sensor 1 comprises a data processing unit μCS, such as a microcontroller, which processes the values of the measurand, e.g., converts them into a different data format. The data processing unit μCS is designed for energy and space reasons to be rather small or economical with respect to the computing capacity and the memory volume. The sensor 1 is thus designed only for “simple” computing operations—for example, for averaging, preprocessing, and digital conversion.

Several sensors 1 can also be connected to a measuring transducer 20. Shown in FIG. 1A are two sensors 1, wherein only one of the two is provided with all of the reference symbols. The same or different sensors can be connected. The left one of the two is shown in the plugged-in state. Up to eight sensors can be connected to the measuring transducer 20, for example.

The sensor 1 can be connected via the physical interfaces 3, 13 to the connection element 11, and ultimately to the measuring transducer 20. The data processing unit μCS converts the value that depends upon the measurand (i.e., the measurement signal of the sensor element 4) into a protocol that the measuring transducer 20 can understand. An example in this regard is, for example, the proprietary Memosens protocol. The first and second physical interfaces 3, 13 are thus designed for the bi-directional communication between the sensor 1 and the measuring transducer 20. As mentioned, in addition to the communication, the first and second physical interfaces 3, 13 also ensure the supply of power to the sensor 1.

The connection element 11 comprises the second physical interface 13, wherein the second physical interface 13 is designed to be complementary to the first physical interface 3. The connection element 11 likewise comprises a data processing unit μCA. The data processing unit μCA may also serve as a repeater for the transmitted signal. Furthermore, the data processing unit μCA can also convert or modify the protocol.

The connection element 11 comprises a second, cylindrical coupling body 12 that is designed to be complementary to the first coupling body 2 and can be slipped with a sleeve-like end portion onto the first coupling body 2, wherein the second physical interface 13 is plugged into the first physical interface 3. An opposite arrangement, in which the second physical interface 13 is designed to be sleeve-like and the first physical interface 3 is designed to be plug-like, is possible, without any inventive effort.

The measuring transducer 20 comprises a display 22 and one or more operating elements 23, such as buttons or rotary buttons, by means of which the measuring transducer 20 can be operated. Measured data, for example, of the sensor 1 are displayed by the display 22. The sensor 1 can also be configured and parameterized by means of the operating elements 23 and the corresponding view on the display 20.

The measuring transducer 20 forwards (communication 35) the measured data via the cable 31, as mentioned, to a control system 30, for example. The control system 30 is in this case designed as a process control system (PLC, SPS), PC, or server.

To this end, the measuring transducer 20 converts the data into a data format that the control system can understand, e.g., into a corresponding bus, such as HART, Profibus PA, Profibus DP, Foundation Fieldbus, Modbus RS485, or even an Ethernet-based field bus, such as EtherNet/IP, Profinet, or Modbus/TCP. These data are then forwarded via the communication 35 to the control system 30. This can, if required, be combined with a web server, i.e., they can be operated in parallel to one another.

FIG. 1B represents an embodiment of a sensor arrangement 10. In this case, only one sensor 1 is respectively connected to a measuring transducer 20. The measuring transducer 20 is in this case illustrated symbolically as a rectangle, is smaller in its dimensions than the measuring transducer from FIG. 1A, and is approximately the size of a matchbox. The measuring transducer 20 can in this case be designed as a separate unit that can be connected to the cable 21 or, as shown here, be integrated directly into the cable 21. The measuring transducer 20 thus consists essentially of the data processing unit μCA. The measuring transducer 20 does not comprise a display and has, if any, only one or two operating elements, which are configured for a reset or for turning on and off. In this embodiment, the measuring transducer 20 preferably comprises no operating elements. The measuring transducer 20 therefore comprises a wireless module 24, such as a Bluetooth module, with the protocol stack, Bluetooth Low Energy. A mobile device (not shown), such as a cellphone, tablet, laptop, etc., can thereby be wirelessly connected to the measuring transducer 20. By means of the mobile device, the sensor can be configured and parameterized using the wireless connection via the wireless module 24. The measuring transducer 20 converts the raw measured data such that they are directly transmitted (communication 35) to a higher-level unit 30, such as the control system. As mentioned, data can, for example, be transmitted in a proprietary protocol from the sensor 1 to the connection element 11, while the data processing unit μCA converts this proprietary protocol into a bus protocol (Modbus, Foundation Fieldbus, HART, Profibus, EtherNet/IP; see above). The measuring transducers in FIGS. 1A-B essentially have the same basic functionality.

As mentioned, the measuring transducer 20 or sensors 1 connected thereto can be operated and parameterized via the operating elements 23. To this end, a menu or menu structure M is displayed on the display 22. The menu structure M describes the hierarchy, navigation, and texts of the various menu pages that are displayed on the display 22. The menu structure M allows for selecting the desired command from an offering and having it executed.

There are parameters and settings that are relevant only to the measuring transducer 20, and there are parameters and settings that are relevant only to the sensor 1. Accordingly, there is a measuring-transducer-specific menu structure MM and a sensor-specific menu structure MS (generally, a field-device-specific menu structure). In the context of this application, measuring-transducer-specific menu pages and their structures are marked with the subscript “M”, and the sensor-specific ones, correspondingly, with the subscript “S.”

If a sensor 1 is connected to a measuring transducer 20, a field-device-specific menu structure MS is transmitted from the sensor 1 to the measuring transducer 20 if said menu structure is not already located on the measuring transducer 20. The sensor-specific menu structure MS is combined with the measuring-transducer-specific menu structure MM in a common menu structure M.

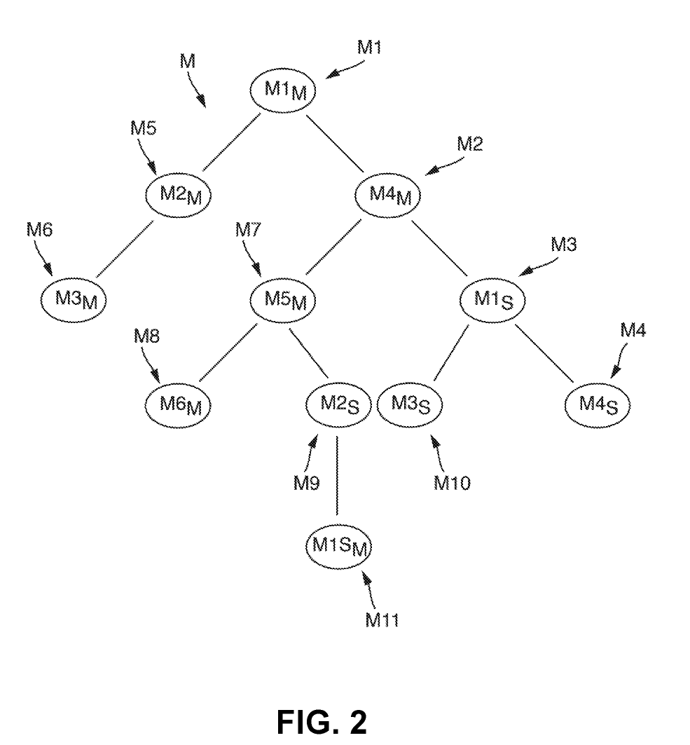

FIG. 2 shows a symbolic representation of a common menu structure M. Presented are some measuring-transducer-specific menu pages M1M-M6M. Further presented are some sensor-specific menu pages M1S-M4S. The common menu structure M is formed from all menu pages M1-M11, which comprise all measuring-transducer-specific and all sensor-specific menu pages.

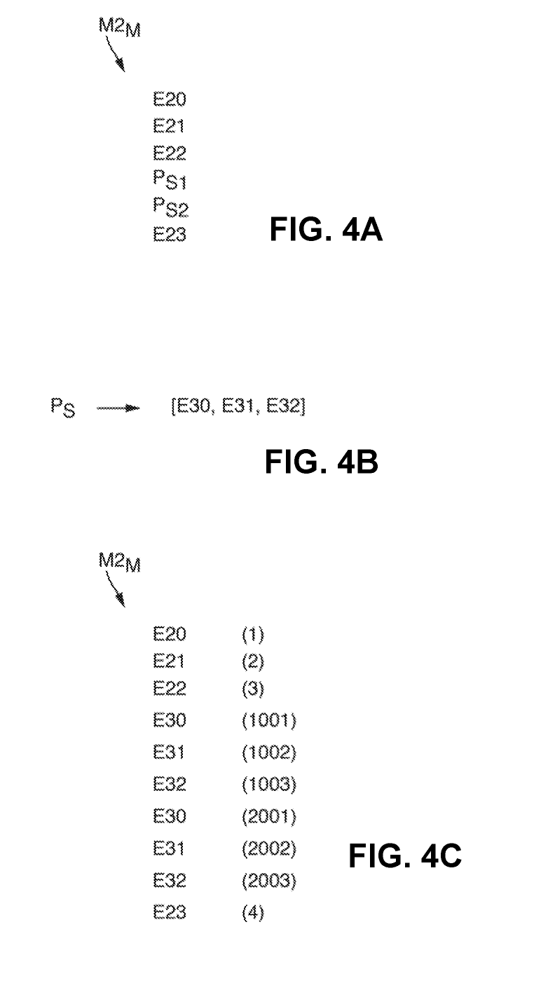

In the menu pages M1-M10, the sensor-specific menu structure MS is combined with the measuring-transducer-specific menu structure MM, menu page by menu page, i.e., either sensor-specific or measuring-transducer-specific elements are found on one menu page. The menu page M11 comprises both sensor-specific and measuring-transducer-specific elements, and therefore has the reference symbol M1SM. In this case, the sensor-specific menu structure is combined with the measuring-transducer-specific menu structure, element by element, in one menu page, which is discussed again below (see, for example, FIG. 4).

A menu page displays hierarchically structured data, wherein these data are, for example, static texts or parameters. A unique identifier ID is assigned to each parameter. An example is shown in the following table:

ID 1 . . . 999->Parameters of the measuring transducer

ID 1000 . . . 1999->Parameters of a first sensor

ID 2000 . . . 2999->Parameters of a second sensor

ID 3000 . . . 3999->Parameters of a third sensor

The common menu structure M is the combination of the menu structures of the measuring transducer and of the first, second, and third sensors. The identifier of the parameter is unique, so that the decision can be made at any time, using the identifier ID, with which sensor the data must be communicated.

Within the menu structure, a distinction is made between the aforementioned hierarchically structured data and their presentation. Display on many end devices is thus possible; ultimately, the measuring transducer 20 decides how the data are displayed. For example, the structure describes that there is a certain number and lines with a certain content. The display itself decides with which font, at which pixel coordinates, etc., these texts are displayed. For example, text can also be displayed in an abbreviated manner or over several lines when it is too long for direct display.

The measuring-transducer-specific menu structure MM is located in the measuring transducer 20. The sensor-specific menu structure MS is combined with the measuring-transducer-specific menu structure MM in the common menu structure M by the measuring-transducer-specific menu structure MM comprising one or more placeholders P or anchor points A. The placeholder P or the anchor point A determines where the sensor-specific menu structure MS is integrated.

An anchor point A is a reference to a complete menu page of the sensor-specific menu structure MS. The anchor point A is only displayed in the common menu structure M if a corresponding menu page exists in the field-device-specific menu structure MS.

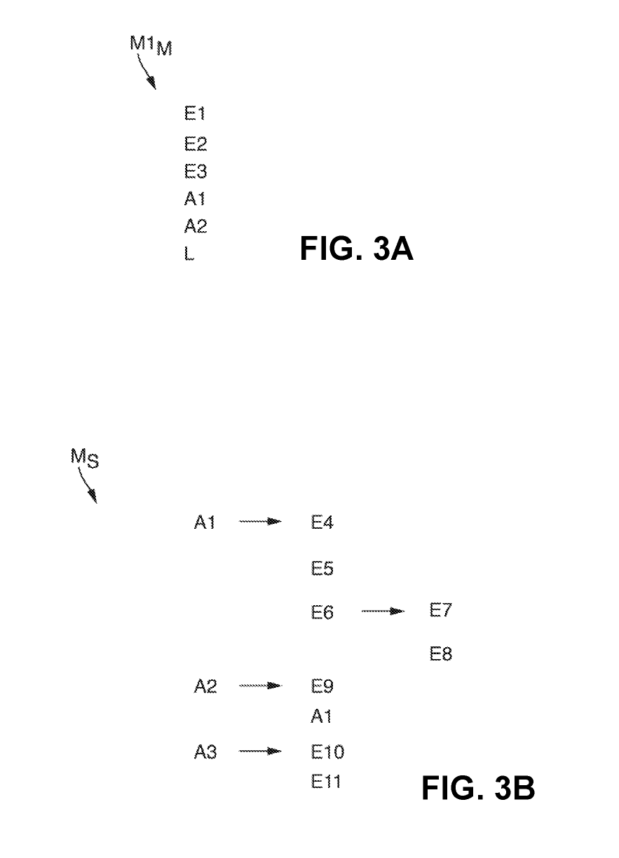

FIG. 3A shows an example of a menu page M1S of a measuring transducer 20. This page M1S comprises the elements E1, E2, and E3. The menu page comprises two anchor points A1 and A2, which respectively point to a separate menu page of the sensor. By selecting the anchor point A1, for example, one jumps to page A1 of the sensor; see in this respect the menu structure MS of the sensor 1 in FIG. 3B. The page A1 comprises the elements E4, E5, and E6. E6, in turn, is a submenu and leads to another page, with the elements E7 and E8. The placeholder A2 comprises an element E9. The placeholder A2 comprises a placeholder A1, i.e., within page A2, jumping to page A1 is possible. It is thus possible not only to jump upwards and downwards within the hierarchy, but also to jump vertically over the hierarchy. In other words, an anchor point can define, not only an entry point to another page (for example, A1 in M1M in FIG. 3A), but also an exit point of a page (for example, A1 in A2 in MS in FIG. 3B).

The menu structure MS of sensor 1 comprises the page A3 with the elements E10 and E11. In the menu structure M1M of the measuring transducer 20, there is, however, no link to A3. Such elements and the page L are therefore collected in the menu structure M1M. The common menu structure M thus comprises a menu page L, which comprises all anchor points A (in FIGS. 3A-B, this is A3) of the sensor-specific menu structure MS that the measuring transducer 20 cannot integrate using the anchor points known to it at the time of its delivery (in FIGS. 3A-B, these are only A1 and A2).

A placeholder P is at least one element of the sensor-specific menu structure MS within a menu page of the common menu structure M.

FIG. 4A shows a menu page M2M of the measuring transducer 20. The page M2M comprises the elements E20, E21, E22, and E23. Between E22 and E23 are located the placeholders PS1 and PS2, wherein S1 and S2 stand for a first or second sensor 1 respectively. The placeholder P comprises the elements E30, E31, and E32; see FIG. 4B. The resulting single page M2M, after connecting two sensors 1 to the measuring transducer 20, is shown in FIG. 4C. The respective identifiers ID are shown in parentheses. The elements with identifiers 2001, 2002, 2003 are shown only if both sensors are connected; only the elements with identifiers 1001, 1002, 1003 are shown with only one sensor.

Another possibility for the conditional display can lie in the parameter itself. For example, temperature-relevant parameters are only displayed if the parameter, “Temperature measurement active,” is selected. Generally, the menu structure depends upon the state of the referenced parameters.

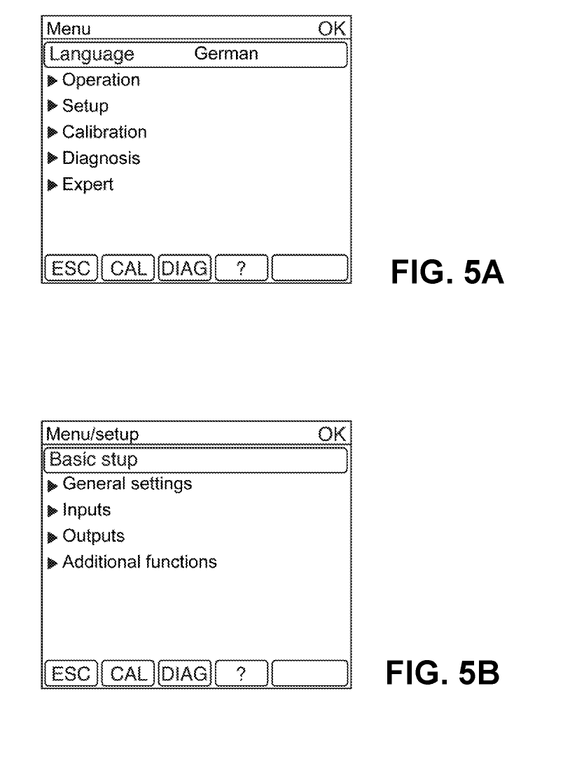

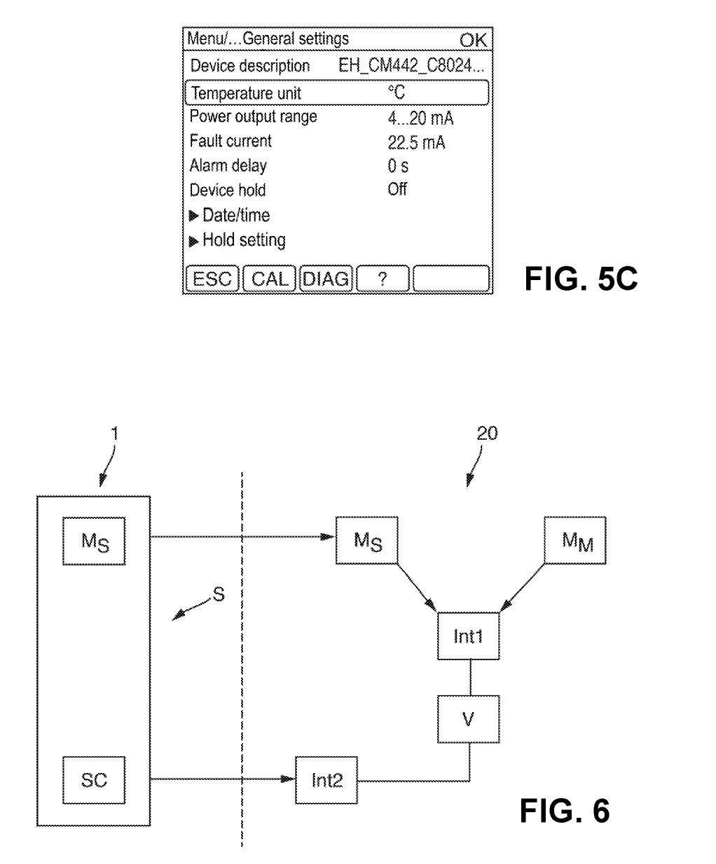

FIGS. 5A-C show screenshots of the display of a measuring transducer 20, which show various situations of the menu structure. FIG. 5A shows a menu page, which contains a parameter and several submenus. Such a submenu is the element, “Operation,” for example. The displayed element, “Setup,” is an anchor point. If a user clicks on it, the menu page, “Setup,” of another menu structure is accessed; see FIG. 5B. The element, “General settings,” for example, is also a submenu, and is shown in FIG. 5C. This page contains already filled placeholders, viz., the elements, “Temperature unit,” “Power output range,” “Fault current,” “Alarm delay” and “Device hold.” These elements were inserted from a menu structure. They are referenced by a placeholder with the name, “GenSettings,” for example, and inserted if available. If this placeholder were not available, only “Device description,” “Date/time,” and “Hold settings” would be displayed.

The measuring transducer 20 comprises a first interpreter Int1, which reads, analyzes, and executes the field-device-specific and measuring-transducer-specific menu structures MS, MM at runtime and creates the common menu structure M. All parameters and elements mentioned are assigned on the basis of the unique identifiers ID. The first interpreter Int1 resolves the parameter references on the basis of their identifiers ID by reading them out via a management unit V, i.e., a unit for assigning the identifiers of the parameters to the databases managing them.

FIG. 6 shows a block diagram of the connection of a measuring transducer 20 and a sensor 1, wherein the sensor 1 was connected as described above. The sensor 1 sends a unique identification to the measuring transducer 20. Based upon this identification, the measuring transducer 20 determines whether the sensor 1, i.e., the type of sensor, is known to it. The measuring transducer 20 comprises a second interpreter Int2, in which an extension 60 is executed. The sensor 1 can interact with the measuring transducer 20 via interfaces, or various interpreters Int2 can also exchange data with each other via the interfaces. This shall be explained in general once again.

First, the measuring transducer 20 is to be started; more precisely, the operating software of the measuring transducer 20 is started. The operating software provides one or more interfaces, which can be used by programs—in this case, in particular, by a second interpreter. The term, “interface,” is to be understood here and below as software interface. The physical interfaces 3, 13 mentioned above, on the other hand, are designed as hardware interfaces.

The interface is the part of a system that is used for communication, i.e., for the exchange of information. The communication between two subsystems is possible only via the interface. It is of no importance to one subsystem how the respective other subsystem handles the information internally and how any responses come about. As mentioned, this concerns software interfaces. Software interfaces are, in general, logical points of contact in a software system: They allow and regulate the exchange of commands and data between various processes and components.

In the next step, a second interpreter Int2 is started on the measuring transducer 20, wherein the interpreter Int2 accesses the interface. Several interpreters Int2 may also be started, wherein a communication between the various interpreters always takes place only via the interface. The interpreter Int2 can be instantiated. In general, an interpreter is a computer program that, in contrast to assemblers and compilers, does not translate a program source code into a file that can be executed directly on the system, but instead reads, analyzes, and executes the source code directly. The program is executed step-by-step during the runtime of the program, without the program being converted into the machine code of the target system beforehand.

In a first embodiment, an emulator—more precisely, a software emulator—is to be understood as interpreter Int2. An emulator is an interpreter, since it executes the machine code of the guest system, command by command, by means of a “virtual processor.” In the example shown, the interpreter Int2 (aka emulator) executes the machine code of the guest system, i.e., of a sensor 1, connected to the measuring transducer 20, or its software interpretation (“sensor-specific software”; see below), command by command, on a “virtual processor” on the measuring transducer 20.

In general, a system that simulates another system in certain partial aspects is called an emulator. The simulated system receives the same data as, executes the same programs as or at least programs comparable to, and achieves results as similar as possible to the system to be emulated. Software emulators are programs that simulate a computer and thus allow the use of software for this computer on a computer with a different architecture.

In the interpreter Int2, at least one extension (per interpreter Int2) is executed. In one embodiment, precisely one extension is executed. Several interpreters Int2 are executed per measuring transducer 20.

Basically, an interpreter Int2 also comprises the special form of a virtual machine, which can execute parts of the machine code of the guest system on the host system.

In one embodiment, the interpreter Int2 is not designed as an emulator, but as a script language interpreter. In one embodiment, this script language is Lua. Other examples are Python, VBA, Lisp, VBScript, or JScript. It is basically also possible to install and start various script language interpreters on a measuring transducer 20. As mentioned, the individual interpreters Int2 communicate with each other via interfaces S. If these interfaces S are then implemented accordingly in the interpreters Int2, communication between the various interpreters Int2 is then also possible.

If the interpreter Int2 is started, an extension is subsequently executed on it. An extension is software that is not primarily a part of the measuring transducer 20, i.e., it is explicitly not part of the operating software. The extension is reloaded at runtime.

In a first embodiment, all sensor-specific components are stored in the sensor 1. The sensor-specific components shall also be called sensor-specific software SC below. The sensor-specific software S is an extension, in the sense of this application. The sensor-specific software S thus constitutes signal processing of sensor data, one or more state machines, parameterization of the sensor, menu structure MS of the sensor, or a field bus connection of the sensor. For this application, the reference S shall refer to the entirety of the sensor-specific software, which consists of the menu structure MS as well as the other parts of the sensor-specific software S, called the sensor code SC.

These software components S are thus located physically in the sensor 1, e.g., in the form of complete software, as byte code. They are, however, executed on the measuring transducer 20 in an interpreter Int2. The first interpreter Int1 serves to execute the menu structure; see below. To this end, the sensor-specific components must be loaded once onto the measuring transducer 20, in order to subsequently be executed within its interpreter Int2. This generally takes place after connecting the sensor 1 to the measuring transducer 20, wherein the data communication protocol, required for the sensor 1, between the measuring transducer 20 and the sensor 1 is used.

The interpreter Int2 is executed on all possible measuring transducers 20 as the same part; only the necessary interfaces to its own components, such as the display, are specific to the measuring transducer, and are adapted accordingly. In doing so, the interpreter Int2 can, for example, be written in a cross-platform programming language like C, so that the source code of the interpreter is, in principle, then the same for all different platforms.

For each sensor 1 connected to the measuring transducer 20, a separate interpreter Int2 is used. Each sensor 1 or its sensor-specific software S is thus executed in a separate interpreter Int2.

As an alternative to storing the sensor-specific software S in the sensor 1, which software is downloaded to the measuring transducer 20 as needed, the sensor-specific software is located on a memory card (such as an SD card), which is inserted into the measuring transducer 20, and transferred to it. In an alternative, the measuring transducer 20 establishes a data connection to the internet and downloads the software suitable for the respective sensor. Alternatively, a connection, e.g., to the control system 30, is established, and the control system 30 keeps the respective software available. Based upon a unique identification of the sensor 1, the respectively correct software is found. In an alternative, the sensor-specific software is already available on the measuring transducer 20. This can, for example, be the case with older sensors, wherein their specific software is already stored on the measuring transducer 20 at the time of delivery of said measuring transducer.

As mentioned, the sensor-specific software S comprises the menu structure MS of the sensor 1 and its software code SC (see above). The measuring transducer 20 comprises its own first interpreter Int1, which interprets the sensor-specific menu structure MS and displays it in a system-specific manner accordingly.

In addition to the generic coupling of sensors 1 and measuring transducers 20 in the sense of the menu structure, this concept offers the advantage that the menu structure is processed by its own interpreter Int1, which can work completely independently of the second interpreter Int2.

What is claimed is:

1. A method to create a menu structure on a measuring transducer of process automation technology, wherein the measuring transducer is embodied to connect to at least one field device, the method comprising:
connecting a field device to the measuring transducer;
when a field-device-specific menu structure is not available on the measuring transducer, transmitting the field-device-specific menu structure from the field device to the measuring transducer; and
combining the field-device-specific menu structure with a measuring-transducer-specific menu structure to create a common menu structure using at least one anchor point or a placeholder in the measuring-transducer-specific menu structure, wherein the measuring-transducer-specific menu structure is located in the measuring transducer,
wherein the at least one anchor point or the placeholder determines where the field-device-specific menu structure is combined into the measuring-transducer-specific menu structure,
wherein the at least one anchor point is a reference to a complete menu page of the field-device-specific menu structure,
wherein the at least one anchor point is displayed in the common menu structure only when a corresponding menu page exists in the field-device-specific menu structure, and
wherein the placeholder is at least one element of the field-device-specific menu structure within a menu page of the common menu structure.

2. The method according to claim 1,
wherein the field-device-specific menu structure and the measuring-transducer-specific menu structure each include hierarchically structured data,
wherein the field-device-specific menu structure and the measuring-transducer-specific menu structure each include a distinction between the hierarchically structured data and a display of the hierarchically structured data, and
wherein the hierarchically structured data of the field-device-specific menu structure and the hierarchically structured data of the measuring-transducer-specific menu structure include static texts or parameters.

3. The method according to claim 2, wherein only the hierarchically structured data of the field-device-specific menu structure are transmitted from the field device to the measuring transducer.

4. The method according to claim 1, wherein the measuring transducer includes a first interpreter configured to read, analyze, and execute the field-device-specific menu structure and the measuring-transducer-specific menu structure at runtime and to create the common menu structure.

5. The method according to claim 4,
wherein the measuring-transducer-specific menu structure references measuring-transducer-specific parameters stored in a first database in the measuring transducer,
wherein the field-device-specific menu structure includes field-device-specific parameters stored in a second database assigned to the field device, and
wherein the measuring transducer further includes a management unit configured to manage the transducer-specific parameters and the field-device-specific parameters and to query the transducer-specific parameters and the field-device-specific parameters from the first database or the second database.

6. The method according to claim 5, wherein the field device includes the second database, and the field-device-specific parameters are stored in the second database.

7. Method according to claim 5,
wherein the measuring transducer further includes at least a second interpreter configured to execute an extension, the method further comprising:
when field-device-specific software is not located on the measuring transducer, transmitting the field-device-specific software from the field device to the measuring transducer after the field device is connected to the measuring transducer,
wherein the field-device-specific software is designed as an extension,
wherein the field-device-specific software includes the field-device-specific menu structure, and
wherein the field-device-specific software further includes the second database in which the field-device-specific parameters are stored.

8. The method according to claim 5, further comprising:
assigning a unique identifier to each field-device-specific parameter and to each measuring-transducer-specific parameter after combining the field-device-specific menu structure with the measuring-transducer-specific menu structure.

9. The method according to claim 3, wherein a menu page to be displayed is not rendered until all hierarchically structured data to be displayed on the menu page are available on the measuring transducer.

10. The method according to claim 1, wherein the field-device-specific menu structure is combined with the measuring-transducer-specific menu structure, menu page by menu page.

11. The method according to claim 1, wherein the field-device-specific menu structure is combined with the measuring-transducer-specific menu structure, element by element, in one menu page.

12. The method according to claim 5, wherein the measuring-transducer-specific menu structure depends upon a state of the measuring-transducer-specific referenced parameters and the field-device-specific menu structure depends upon a state of the field-device-specific referenced parameters.

13. The method according to claim 1, wherein the at least one anchor point defines an entry point or an exit point.

14. The method according to claim 1, wherein the common menu structure includes a menu page that includes all anchor points of the field-device-specific menu structure that the measuring transducer cannot integrate using anchor points known to the measuring transducer when the measuring transducer was manufactured.

15. A measuring transducer comprising:
a computing unit including a memory;
a persistent memory;
a first database stored in the persistent memory, wherein the first database includes measuring-transducer-specific parameters;
a first interpreter configured to interpret abstract formulations of a menu structure;
a second interpreter configured to execute field-device-specific software on the measuring transducer;
an operating software configured to execute a method to create a menu structure, the method including:
connecting a field device to the measuring transducer;
when a field-device-specific menu structure is not available on the measuring transducer, transmitting the field-device-specific menu structure from the field device to the measuring transducer; and
combining the field-device-specific menu structure with a measuring-transducer-specific menu structure to create a common menu structure using at least one anchor point or a placeholder in the measuring-transducer-specific menu structure, wherein the measuring-transducer-specific menu structure is located in the measuring transducer,
wherein the at least one anchor point or the placeholder determines where the field-device-specific menu structure is integrated into the measuring-transducer-specific menu structure,
wherein the at least one anchor point is a reference to a complete menu page of the field-device-specific menu structure,
wherein the at least one anchor point is displayed in the common menu structure only if a corresponding menu page exists in the field-device-specific menu structure, and
wherein the placeholder is at least one element of the field-device-specific menu structure within a menu page of the common menu structure.
